(19) United States
(12) Patent Application Publication
(10) Pub. No.: US 2006/0223044 A1
(43) Pub. Date: Oct. 5, 2006

(54) ISFN DB method to construct international library of well architected contents having multilingual capability

(76) Inventor: Hassan Behbehani, Kuwait (KW)

Correspondence Address: Hassan Behbehani, P.O. Box: 1262 Safat,, 13013 Safat,, Kuwait, KW

(21) Appl. No.: 11/097,230

(22) Filed: Apr. 4, 2005

(51) Int. Cl. G09B 25/00

(52) U.S. Cl. 434/365

(57) ABSTRACT

Pictures or Figures can be understood very quickly. The global meaning or the gist of a picture can generally be attained in an easy and rapid way, in as little as 300 ms (Peeck 1993:228). This “gives the illusion of full understanding” and so “students often deal with illustrations in a superficial and inadequate way” (Peeck 1993:228). When textbooks become heavily illustrated, this effect of pictures can distract from learning. The presented invention is based on the simple fact stated as above.

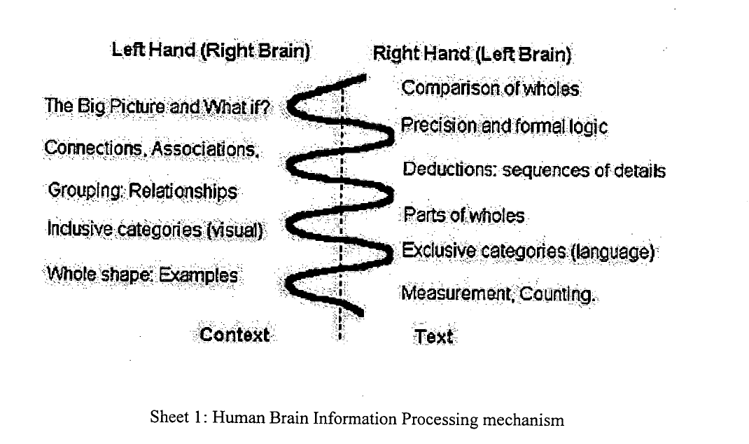

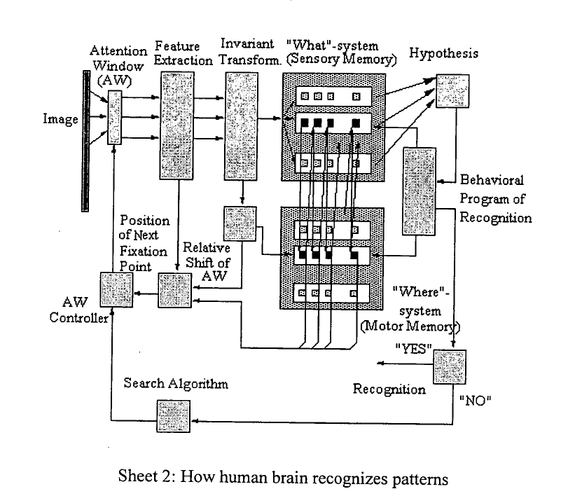

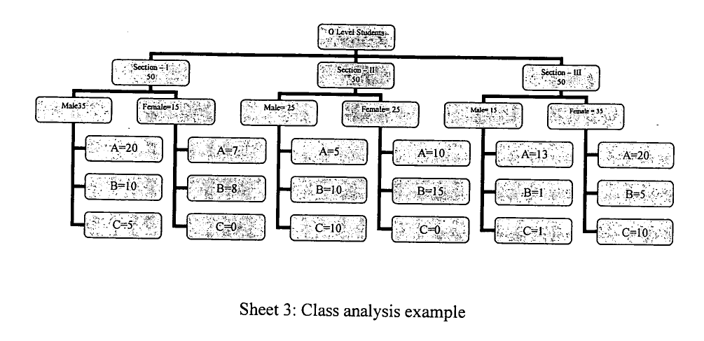

### REFERENCES

1. Allender, Jerome S. (1991). Imagery in teaching and learning: an autobiography of research in four world views. New York: Praeger.
2. Baggett, P. (1979). Structurally Equivalent Stories in Movie and Text and the Effect of the Medium on Recall. Journal of Verbal Learning and Verbal Behavior, 18, 333-356.
3. Bajo, Maria-Teresa. (1988). Semantic Facilitation With Pictures and Words. Journal of experimental psychology: Learning, 14 (4), 579-589. Bartlett, J. C., Till, R. E., & Levy, J. C. (1980). Retrieval Characteristics of Complex Pictures: Effects of Verbal Encoding. Journal of Verbal Learning and Verbal Behavior, 19, 430-449.
4. Benson, D. F. (1981). Alexia and the Neuroanatomical Basis of Reading. In Pirozzolo Francis J., & Wittrock, Merlin C. Neuropsychological and cognitive processes in reading (pp 69-92). New York: Academic Press.
5. Butler, Darrell L. (1993). Graphics in Psychology: Pictures, Data, and Especially Concepts. Behavior research methods, instruments, & computers, 25 (2), 8192.
6. Chanlin, Lih-Juan. (1997). The Effects of Verbal Elaboration and Visual Elaboration on Student Learning. International journal of instructional media. 24 (4), 333-339.
7. Debaryshe, Barbara D. (1993). Joint picture-book reading correlates of early oral language skills. Journal of child language, 20 (2), 455-461.
8. Di Vesta, Francis J., Ingersoll, Gary, & Sunshine, Phyllis. (1971). A Factor Analysis of Imagery Tests. Journal of verbal learning and verbal behavior, 10, 471-479
9. Doerr, Johanna. (1999). Compare and contrast two cognitive theories of human visual perception, with particular reference to the role played in each theory by prior knowledge. http://www.lancs.ac.uk/socs/lumss/nephridium/essay-Mayer, Richard E., Bove, W., Tapangco, Lene. (1996). When Less Is More: Meaningful Learning From Visual and Verbal Summaries of Science Textbook Lessons. Journal of educational psychology 88 (1), 64-73.
10. Mayer, Richard E. & Moreno, Roxana. (1998). A Split-Attention Effect in Multimedia Learning: Evidence for Dual Processing Systems in Working Memory. Journal of educational psychology, 90 (2), 312-320.
11. Mayer, Richard E., & Sims, Valerie K. (1994). For Whom is a Picture worth a thousand words? Extensions of a Dual-Coding Theory of Multimedia Learning. Journal of Educational Psychology, 86 (3), 389-401 McKoon, G. (1977). Organization of Information in Text Memory. Journal of Verbal Learning and Verbal Behavior, 16, 247-260.
12. Mehler, J. (1963). Some Effects of Grammar Transformations on the Recall of English Sentences. Journal of Verbal Learning and Verbal Behavior, 2, 346-351.
13. Moeser, S. D., & Bregman, A. S. (1973). Imagery & Language Acquisition. Journal of Verbal Learning and Verbal Behavior, 12, 91-98.
14. Walter KLINGER Effects Of Pictures On Memory & Learning 2000/09

### BACKGROUND OF THE INVENTION

A picture is worth a thousand words, or so the saying goes a saying debated by some but accepted pragmatically by most. Do we not all remember some little drawing or other that came in handy to clarify an otherwise plainly unintelligible discourse? Professionally, experienced technical communicators know the benefit of adding illustrations to the text of their technical publications. With increasingly better tools available for their production, pictures seem to have a bright future indeed. For example just have a look on it.

“Thank you for trying to give me directions, but it's too confusing to me. Would you mind drawing a map for me? A picture is worth a thousand words.”

Verbal and nonverbal processes are complementary. To a point, they can be performed independently and do not seem to compete for the same intellectual resources. For example, players of visual computer games such as Tetris, can keep on chatting with onlookers while engaging in purely visual reasoning against the clock (making decisions about where and in which orientation to place the falling shapes). Similarly, students can doodle and still not miss a word the teacher is saying. And drivers can talk on their cellular phones and keep their cars on the road. Sequential processes, however, are mutually exclusive: students chatting among themselves, for example, can no longer listen to the teacher, and drivers engaged in a phone conversation are less able to react to unexpected circumstances that require reasoned decisions. Nonverbal processes, by contrast, can more easily coexist.

Mental processes are complex, multiple, and still poorly understood. Pragmatically, they can be modeled along various axes. Some processes are rational, able to manipulate more abstract, more intangible concepts, whereas others are intuitive, almost unconscious, and possibly innate. Some processes are clearly sequential, having a beginning, a middle, and an end, and therefore appear slow, while others seem—for all practical purposes—instantaneous or simultaneous. From a communication point of view, some processes are symbolic, able to manipulate a human language or language-like references or constructs, while others are not.

As world is getting the shape of the global village, there is sea of information available and this sea is growing day by day. Its becoming difficult to find the required information as the probability of availability of information is increasing. As there is cost of everything therefore the cost of this huge information availability is complexity and difficulty the people face in order to search their required information.

First complexity is as humans have many languages therefore the information available is also in many languages and its not necessary information available in one language should also be exist in other language. The translation can be considered as an effective tool to resolve this problem. There are also tools that can auto translate the contents of one language into the other language thus proving translation as more effective tool. But this is not the end of story, though we have auto translation still there are more problems within the translation itself. The efficiency of auto-translation depends of the length and simplicity or complexity of the text structure. Whenever the text is longer and more complex structured, we get worse auto translation results even funny sometimes whereas if the text is shorter and simple structured, we get better auto translation results. For example: it's such easier to auto-translate “Problem's reasons” than “the reasons which may cause the problem”

Unfortunately, most of text are written in the grammatical jugglery. Though it is necessary to make the material interesting for the readers as dry stuff is not easy to digest but this creates problems for the auto translation tools. That's why we get weak contact and knowledge exchange between countries and civilizations which have deferent languages, such us China and Germany!

The second complexity begins after targeting the desired destination. As destination has lot of information available therefore to sort out the required information is another problem. You may find tons of text talks about very few core concepts, which can be written in much less text. That's why you will need mostly, a huge period of time to scan the related text about your topic, and make sure that you've read what has been written about it. This problem has been viewed recently, after IT revolution and e-search tools. And it's clearly notable when you search for a topic and find huge number of pages has been written about it, and after browsing some of them you get a negative impression about that quantity of text, and think that the original concept has been stretched extremely and the core expressions about the concepts which tell you the story in few words have been lost in this textual jungle, and recall the concept of Text Fatness! Many factors shared developing this problem to worse status. Such as the commercial and prestigious factors which force author to talk more until author gets a good thickness which make since to pay a money for in the bookstore, or refer to as an article or book.

Let's consider a scenario a below.

“How do I print my letter?”

“Open the letter, the select print, and hit ok.”

Clearly these people are discussing a particular action to be taken at a computer. However, their conversation doesn't hinge on the actual motions involved:

“Place your hand on the device next to the keyboard. Move that device, which causes movement of the black arrow on the bright TV-like device on your desk, so that the black arrow is on top of the white square, which has text below with the name of your letter, and click twice, in rapid succession, on the button at the top of the device in your hand . . . ”

Obviously it will take some precious time to understand the solution. But just imagine if this solution is presented in form of figure or picture then it would be few seconds game to understand the whole procedure.

Those two problems play a critical rules to design our media, then our libraries and archives. In the day that we can develop an advanced solutions to skip those two problems, we will redesign our knowledge contents and media, actualize the great dream of Universal E-Library that enable browsers to maximize their reading, and minimize the needed resources for that, such as time. So they well learn more with less content that has more quality within less quantity! And the great effects would be immediately reflected over all specialties and researches fields, specially between the deferent language's countries and civilizations, and researchers get in such advanced positions.

The presented invention is an attempt to address the two major problems as mentioned below. The presented invention suggests to use international standard figures rather than textual contents because textual contents are difficult to explore and if another language then difficult to translate most of the times. The American Association for the Advancement of Science annual meeting in the US is debating whether the language we speak affects the way we think. How closely are cultural and national identities defined by language?

In general, a figure (also known as scheme) is any form of expression in which, as Quintilian writes, “we give our language a conformation other than the obvious and ordinary”. That is, a figure is a piece of language (typically more than a single word) that has an unusual arrangement; its purpose is to change the shape of language, as the purpose of a gesture is to change the shape of the body. Figures of thought involve artful changes in ideas, concepts, or reasoning, whereas figures of speech involve artful changes in the actual structure of language. The difference between figures of thought and speech is slight, and rhetoricians have struggled for millennia to categorize them effectively. Whereas a figure preserves the literal meaning of the words but arranges (or rearranges) them artfully, a trope transforms the actual meaning of the word or phrase. Hence, a trope is the use of a word or phrase to mean something other than its ordinary meaning. Technically speaking, a trope is a type of figure of speech, a figure of speech in which only a single word is used rather than multiple words or a phrase.

Graphical representations preserve geometric and topological information, whereas text has an arbitrary relationship to the object that it represents (e.g., Larkin & Simon, 1987; Schnotz, 2002). There is abundant evidence that presenting information either graphically or textually influences learning. Scaife and Rogers (1996) proposed that graphical representations bring advantages for learning by computational offloading, re-representation and graphical constraining: Computational offloading is the extent to which different external representations reduce the amount of cognitive effort required to solve equivalent problems. For example, Larkin and Simon (1987) showed how search processes are considerably more efficient in diagrammatic rather than textual representations and proposed that text often has a high cost of perceptual enhancement. Re-representation refers to the way that alternative external representations that have the same abstract structure, differentially influence problem-solving. Zhang and Norman (1994) showed that problem-solving with isomorphic versions of the Towers of Hanoi was enhanced when representations externalized more information. By utilizing external perceptual processes rather than cognitive operations, graphical representations will often be more effective.

Graphical constraining describes the limits on the range of inferences that can be made about the represented concept. Stenning and Oberlander (1995) argue that text permits expression of ambiguity in the way that graphics cannot easily accommodate. It is this lack of expressiveness that makes diagrams more effective for solving determinate problems. In short, the presented invention will have following general advantages:

Exploit the General Advantages of Figures

General Advantages of Database Systems

The ISFN will be unique identifier for a specific figure internationally so researchers, students and other involved entities will be easy able to locate required information.

It will save much time which can be spent in other activities such as analyzing and locating the information.

It would be more flexible way to sort out required contents.

Updated research information would be easy available to interested entities

Readers having different native languages will be able to accurately translate the contents as figures have less text and its easy to translate the less text

Figures database will be available that can be searched easily

Cheerful, interesting illustrations provide motivation to study.

International students will be benefited because figures can be understood quickly

If constructed effectively the invention can be used to setup an international standard figures library. This library can even be specific to one field such as medicine, petroleum . . . etc or it can be at higher level such as Science, Arts . . . etc. The library construction depends how we are going to use the invention.

### BRIEF SUMMARY OF THE INVENTION

The presented technique reveals a method to assign an internationally unique identification number or unique id to specific sort of figures related with a particular category or specific subject. The idea is to assign a internationally unique number to figures so that researchers, readers, students and other interested entities can easily locate their required information and can choose high quality contents with the found material. Like ISBN, an idea to assign internationally unique identification number to single FIGURE internationally is revealed known hereby as ISFN (International Standard Figure Number). The figures which are same semantically, logically with linguistic and other differences undergo the same internationally unique identification number though a language code can be included or appended in the unique number itself.

### BRIEF DESCRIPTION OF THE DRAWINGS

The specification is accompanying three drawings.

Sheet 1:

Figure to explain processing of human brain.

Sheet 2:

Figure to explain how patterns are recognized in human brains.

Sheet 3:

An example how the figures are effective in analyzing huge information. The example is of class having three different sections. Each class have specific number of students. Then there is information how many students get a specific grade in the section.

### DETAILED DESCRIPTION OF THE INVENTION

Many studies show that pictures can be helpful in introductory material for students with low prior knowledge of a study topic. This group of students includes children learning to read and students beginning foreign language studies. But pictures can also distract from learning to read text. The critical factor in learning to read alphabetic scripts, say Huang & Hanley (1995:74), is to “isolate and manipulate individual phonemic units,” so the most important visual skill is “orthographical rather than pictorial or logographic.” However, excellent visual memory skills can be a “significant advantage” in learning to read non-alphabetic scripts like Chinese characters (Huang & Hanley 1995:93).

The presented invention is as also about figures or pictures. The invention suggests to assign a unique primary id to every image or picture arranged in for of a database.

The invention necessarily comprises a database preferably a relational database. The database may have different objects (tables) where in the figures will be stored. The suggested database may have additionally indexing services in order to locate the required pictures easily and quickly.

Each object (Database) may have further columns according to the required setup. The number of columns in the database depend on how the invention described can be used according to various requirements. Moreover different indexes can be defined on the database according to the nature of the requirements.

The invention introduces a new concept of international standardization in order to classify or group the same sort of figures under a unique number worldwide so that people easily can access and identify the required image.

The unique number assigned to a specific figure is unique to all the same sort of figures that have similar semantic and logical meanings internationally no matter what the language is used in figures.

The unique number or ISFN assigned to a figure internationally is variable in length and is customizable. The number format is also customizable and may include or appended with additional code such as language code so that people are able to identify figures according to their language interest.

Like ISBN and ISQN, ISFN may also contain the subject information and this subject may be further drilled down to atomic division in form of questions & figures. The ISFN number is also variable in length but after standardization all the ISFN will be of same length and same format. The ISFN may also be alphanumeric and may contain special characters as well such as dashes, hyphens and spaces etc. The ISFN may use other numbering system as well such as hex, octal or roman numbering systems.

Once the ISFN is assigned to a specific figure as described earlier it will be unique always. Any printed materials, publications or electronic contents that have reference to specific ISFN are grouped under one ISFN. So one ISFN may have hundreds of books or publications attached with it. So one publication or electronic publication or some sore of material having contents that can deliver some sort of information in figures, text, audio or video form may have multiple ISFN numbers because one publication may have many figures.

What I claim as my invention is:

1. A method to assign an internationally unique identification number or unique id to particular figure(s) related with a particular industry or specific subject, comprises the steps of:
analyzing the figure(s) under process
categorizing the each figure
Assign a internationally unique identification number to each figure
Release the numbers for assigning to publications and other materials

2. A method as claimed in claim 1, wherein the said figures may be analyzed manually or through some other electrical, electronic or mechanical devices such as computer, scanners . . . etc.

3. A method as claimed in claim 1, wherein categorizing the each figure step may be performed manually or automatically in some way.

4. A method as claimed in claim 1, wherein figures can be categorized into one or multiple categories.

5. A method as claimed in claim 1, wherein figures can have categories and further sub categories. Each further sub category may have again sub categories and so on.

6. A method as claimed in claim 1, wherein the internationally unique identification number's format is customizable.

7. A method as claimed in claim 1, wherein the internationally unique identifcation number's assigned to each figure is unique including all the previously assigned unique numbers.

8. A method as claimed in claim 1, wherein the internationally unique identifcation number's may include additional parameters for easy identification such as language code to identify the language of the text associated with figure. These parameters are considered as additional parameters and are not part of standard unique number itself.

9. A method as claimed in claim 1, wherein the figures which are same semantically, logically with linguistic and other differences undergo the same internationally unique identification.

10. A method as claimed in claim 9, wherein a additional code such as language code can be included or appended in the unique number itself.

11. A method as claimed in claim 10 wherein the said unique ids can be generated automatically or manually according to specified certain criteria and format.

12. A method to keep record of internationally unique identification numbers or unique ids to specific figure(s) wherein unique ids again are assigned to figure(s) to identify exactly what figure(s) are related with a particular industry or specific subject, comprises the steps of:
A database or some other sort of data repository to store unique ids
Wherein the said database is also able to store other related information with unique ids such as the figure(s) to which these numbers were assigned . . . etc and specified format of unique ids according to which unique ids are generated.

13. A method as claimed in claim 12, wherein the said database can shared and distributed over network, world wide web, computers and other devices capable of storing data such as palm devices, mobile phones, computer chips, computer memory, cd, dvd, tape . . . etc.
